(19) United States
(12) Patent Application Publication
(10) Pub. No.: US 2020/0362693 A1
(43) Pub. Date: Nov. 19, 2020

(54) Sensors For Measuring Properties In Isolated Zones In A Pipeline Or Wellbore

(71) Applicant: Board of Regents, The University of Texas System, Austin, TX (US)

(72) Inventor: Mohsen Ahmadian-Tehrani, Austin, TX (US)

(73) Assignee: Board of Regents, The University of Texas System, Austin, TX (US)

(21) Appl. No.: 16/875,493

(22) Filed: May 15, 2020

Related U.S. Application Data
(60) Provisional application No. 62/848,785, filed on May 16, 2019.

(51) Int. Cl. E21B 49/00; G01V 9/00; E21B 43/26; E21B 43/14; E21B 33/12; E21B 34/06; E21B 49/08; E21B 47/11

(52) U.S. Cl. CPC E21B 49/00; G01V 9/00; E21B 43/26; E21B 43/14; E21B 47/06; E21B 34/06; E21B 49/0875; E21B 47/11; E21B 2200/06; E21B 33/12

(57) ABSTRACT

Sensor systems for performing in-wellbore and/or in-fracture measurements of physical and/or chemical properties are injected into a wellbore (such as within a subterranean formation) or pipeline. The sensor systems each contain one or more sensors, which include a capability to communicate results of the measurements to an external device. Different sensor systems are injected into different isolated zones within the wellbore or pipeline to obtain measurements of the particular physical and/or chemical properties within each zone.

This application claims priority to U.S. Provisional Application Ser. No. 62/848,785, which is hereby incorporated by reference herein.

### TECHNICAL FIELD

This disclosure relates in general to a sensor system for performing a variety of in-wellbore/pipeline physical and/or chemical measurements in various applications, including for oil and/or gas operations.

### BACKGROUND INFORMATION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In certain wellbore operations, various treatment fluids/gases/clutter may be pumped into the well and eventually into the subterranean formation to restore or enhance the productivity of the well. For example, a non-reactive fracturing, or “frac,” fluid may be pumped into the wellbore to initiate and propagate fractures in the formation, thus providing flow channels to facilitate movement of the hydrocarbons to the wellbore so that the hydrocarbons may be pumped from the well. In such fracturing operations, the fracturing fluid is hydraulically injected into a wellbore penetrating the subterranean formation and is forced against the formation strata by pressure. The formation strata are forced to crack and fracture, and a proppant may be placed in the fracture by movement of a viscous fluid containing proppant into the crack in the rock. The resulting fracture provides improved flow of the recoverable fluid, e.g., oil, gas, and/or water, into the wellbore.

In certain wells (e.g., vertical, horizontal, or lateral wells) with multiple production zones, it may be necessary to treat various formations in a multi-stage operation requiring repeated “trips” downhole. Each trip generally includes isolating a single production zone (e.g., a hydraulic fracturing stage) and then delivering the treatment fluid to the isolated zone. Since multiple trips downhole are required to isolate and treat each zone, the completion operation may be very time consuming and expensive. In certain other applications, multiple perforated zones may be injected into or produced from. During the life of a well, it may be necessary to pack off the producing zones that are producing undesired fluids or gases, and zonal isolation or plugs are deployed. In other applications after the well has produced a majority of its production, wells are plugged and abandoned. Understanding the chemical and physical makeup of each zoned section of the well would be important to the economic, productivity, and environmental impact of each well. In addition, packers and zonal isolation may also be utilized as a fluid/gas diversion strategy for injecting into a specific zone of interest to improve or enhance recovery.

Wellbores are historically characterized using measurement equipment lowered or pulled into wellbores that are tethered to the surface with mechanical and electrical cables (often referred to as wireline logging techniques). Wireline logging requires significant surface infrastructure, operator labor, and production downtime, and thus significant cost to the well operator to obtain the wellbore data.

### BRIEF DESCRIPTION OF THE DRAWINGS

FIG. 1 illustrates a schematic of a wellbore in which embodiments of the present disclosure are injected.

FIG. 2 illustrates a flow diagram configured in accordance with embodiments of the present disclosure.

FIG. 3 illustrates a block diagram of a sensor system configured in accordance with various embodiments of the present disclosure.

### DETAILED DESCRIPTION

Aspects of the present disclosure provide either individual or multiple miniaturized electronic sensor systems distributed within isolated zones, which enable direct measurements in locations that are currently difficult or impossible to access (e.g., pipelines, subsea tubulars, pumping stations, drill strings, wellbores, and natural and induced fractures) and/or with higher resolution. Within embodiments of the present disclosure, including those that are recited within the claims, the term “wellbore” may include any portion of piping utilized within the exploration, production, and transportation of hydrocarbons (e.g., pipelines, subsea tubulars, pumping stations, drill strings, wellbores into subterranean formations).

Aspects of the present disclosure provide a sensor system (which may be reusable) for performing a variety of in-wellbore/pipeline physical and/or chemical measurements in various applications, including oil and/or gas operations, fluid injection and production, CO₂ sequestration, geothermal energy production, or any other subterranean or aboveground applications involving carriers, or proppant, fluid or gas flow, or combination thereof, in or out of a wellbore, where zonal isolation enables separation of sensor systems in specific pipeline/wellbore zones to measure a variety of in-wellbore physical and/or chemical measurements, which may not be easily possible with existing wireline technology.

Sensor systems described in this disclosure can eliminate/reduce the need for wireline/wired measurements. Such sensor systems can be deployed in specific isolated zones and used to obtain data streams from regions of the wells that are not routinely interrogated during injection, production, or completion, thereby enhancing the productivity and reducing the cost of operations.

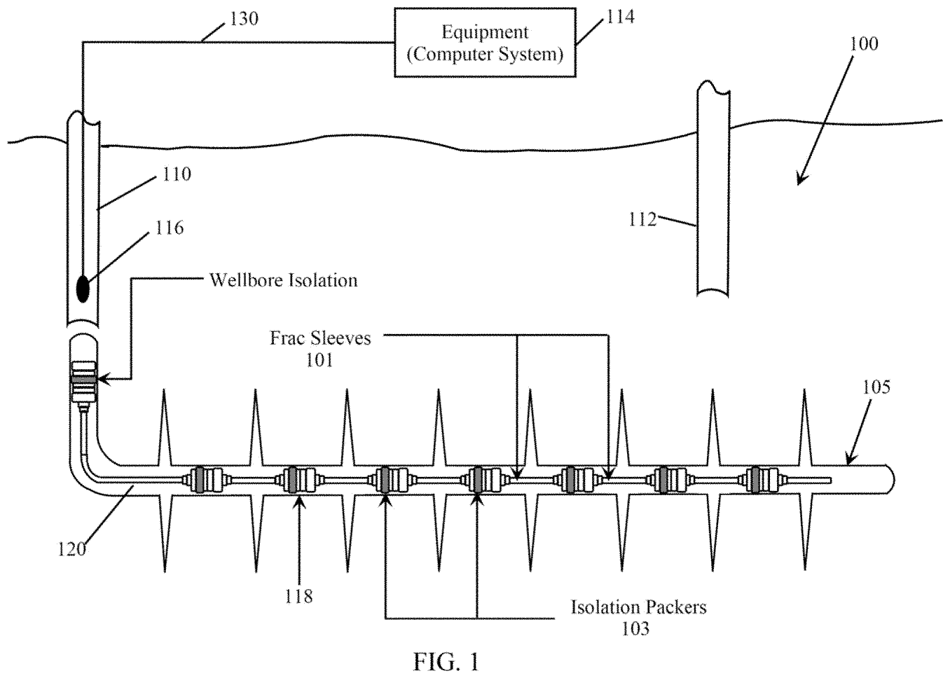

Referring to FIG. 1, to overcome the disadvantages with multi-trip zone isolation and treatment within wellbore operations, a wellbore isolation mechanism (e.g., a series of sleeves and/or valves 101 and isolation packers 103, such as within a completion string) may be inserted and spaced along the length of the lateral and/or vertical wellbore 105, allowing the isolation of multiple zones (which may also include selective fracturing in each zone in a continuous selectively controlled operation (herein also referred to as “fracture zones”)). In accordance with embodiments of the present disclosure, a wellbore isolation mechanism may include any mechanism suitable for isolation of a wellbore or pipeline into multiple zones, which may be, but not necessarily contiguous with each other.

An exemplary method for creating multiple fractures in a formation 100 along a wellbore 105 is the use of frac ports and sliding sleeves implemented within a completion string placed inside the wellbore 105. Packers 103, which isolate different sections of the wellbore 105, are actuated by mechanical, hydraulic, or chemical mechanisms. In order to activate each sleeve 101, one or more properly sized fracture stage balls (“frac balls”) (not shown in FIG. 1) are selectively injected (e.g., pumped) along with a fracturing fluid 120 from an injection well 110 into the wellbore 105. Each frac ball is smaller than the opening of all of the previous sleeves it is intended to pass through, but larger than the sleeve it is intended to open. Seating of the frac ball exerts pressure at the end of the sliding sleeve assembly, causing it to slide and open the frac ports. Once the ports are opened, the fluid 120 is diverted into the open hole space 100 outside of the completion assembly, causing fracturing of the formation 100 surrounding the selected fracture zone. At the completion of each fracturing stage, the next larger frac ball is injected into the wellbore 105, which opens the next sleeve, and so on, until all of the sleeves are opened and multiple fractures are created in the formation 100. Alternatively, a plug and perforation string is used to isolate and stimulate each stage, and the plug is then milled out to put the well into production. These isolation and completions strategies are known to practitioners in hydraulic fracturing. Although embodiments of the present disclosure are described with respect to the use of fracball and slide sleeve technology, other zonal isolation and stimulation techniques can be substituted. Additionally, zonal isolation can be practiced in both open borehole or in a cased borehole.

Embodiments of the present disclosure may be implemented by injecting a fluid containing one or more sensor systems into each isolated zone (e.g., successively ahead of a fracball and/or plug isolating one zone and after the next fracball/plug is deployed to isolate the next zone). In accordance with embodiments of the present disclosure, such a fluid may include a fracking fluid (e.g., the fluid 120), which may also include additives and proppants.

It would be further desirable to be able to perform measurements of various physical and chemical properties present within the wellbore 105 and/or in the fractures in the formation 100. For example, it would be desirable to determine certain physical and/or chemical properties associated with the production of each of the fracture zones (e.g., pressure, temperature, resistivity, pH, ion charge, and/or proportion of oil and water, CH₄ and/or CO₂ content, etc. of the production fluid associated with each fracture zone). All such properties are referred to herein as simply “physical properties.”

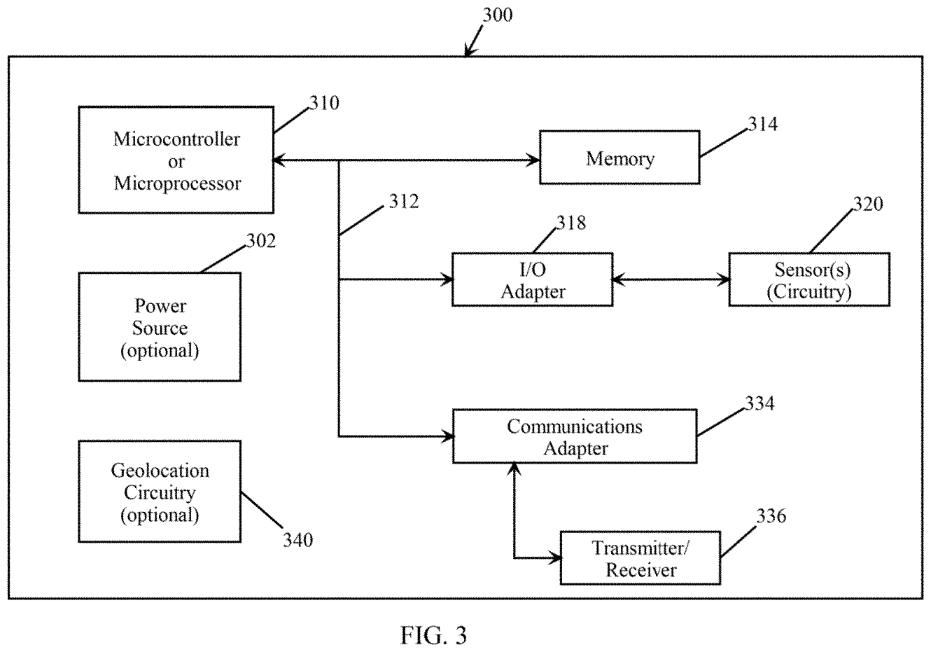

With reference now to FIG. 3, a block diagram illustrating a sensor system 300 is depicted in which aspects of embodiments of the disclosure may be implemented. In embodiments of the present disclosure, one or more of the sensor systems 300 include one or more sensors 320 (which may include associated sensor circuitry) that make one or more measurements (including in real-time) of physical properties (which may include physical and/or chemical conditions associated with the wellbore 105 and/or the production fluid from the formed fractures 100, and store information associated with such measurements (including in a time-stamped and/or geolocated manner) to an associated memory 314.

The sensor system 300 may employ a local bus architecture 312. The bus architecture 312 may permit communication between a microcontroller, microprocessor, or any suitable programmable device 310 with a (volatile and/or nonvolatile) memory 314, an input/output (“I/O”) adaptor 318, and a communications adapter 334. An optional power source 302 may be included within the sensor system 300 for providing power to the sensor system 300. An I/O adapter 318 may be provided in order to communicate with one or more sensor 320, which have been described herein with examples. The communications adapter 334 may communicate with a transmitter/receiver 336, which may be utilized to permit transfer of data and information between the sensor system 300 and any external systems, such as equipment 114 utilized to retrieve the measurements obtained by the sensors 320 by the sensor system 300. The transmitter/receiver 336 may include any suitable communication means, which includes acoustic, seismic, electromagnetic, optical, magnetoacoustics, and wired or wireless radio frequency (“RF”), such as Bluetooth.

In accordance with embodiments of the present disclosure, a plurality of such sensor systems 300 may be deployed into each zone, including where different sensor systems 300 are configured with sensors 320 that measure or sense different physical properties. The sensor system(s) 300 may each operate autonomously from each other, or may coordinate and/or communicate with each other to obtain measurements of a particular physical property. The sensor system(s) 300 may store such information in the memory 314, which may be stored in the memory 314 as data tables that correlate the measured properties to other measured physical properties and/or a geolocation and/or time. Such properties may include time, temperature, pressure, pH, resistivity, ion charge, proportion of oil and water, CO₂, CH₄, and other hydrocarbons, acoustic/seismic detector, a magnetometer, impedance analyzer to measure, dielectric, conductivity, acoustic sensor, optical sensor, and/or casing collar counter. Though the sensor system(s) 300 may be powered by an included (optional) power source 302, one or more sensor systems 300 may also be passive devices that provide information without the utilization of a power source. Such sensor systems 300 may include an energy harvesting module or an antenna that can be powered by surrounding environment, such as with RFID devices.

Though one or more of the sensor systems 300 may be autonomous in that they operate autonomously from each other, one or more sensor systems 300 may be implemented to communicate with each other using such a transmitter/receiver 336, or some sort of wired connection between such sensor systems 300. Furthermore, an optional power source 302 may be implemented for each of the powered sensor systems 300. Sensor powering and communication may be facilitated by surrounding media or by specially designed electromagnetic, energetic, acoustic proppants, solid clutters, or additional wellbore infrastructure.

Geolocation of the sensor systems 300 may be obtained through the use of embedded geolocation circuitry 340 (e.g., circuitry that includes a gyroscope, accelerometer, compass, acoustic means, magnetic means, 9-axis motion tracking means, or by counting casing collars).

Examples of sensor systems 300 are disclosed in U.S. Pat. Nos. 8,638,106, 9,291,586, 9,494,023, 9,518,950, 9,950,922, 9,994,759, 10,006,823, and 10,254,173, U.S. Published Patent Application No. 2018/0003851, and International Patent Application No. WO2016/081718, which are all hereby incorporated by reference herein. As with some of these exemplary sensor systems, they may be implemented as passive sensors without electronic circuitry such as a microcontroller, microprocessor, or other programmable device 310 and associated memory 314.

In today's multistage hydraulic fracturing jobs, a single wellbore (e.g., wellbore 105) can have as many as 30-50 fracture stages, with a stage-to-stage variation in production as great as 100%, where some stages produce nothing, and other stages produce millions of cubic feet of oil and/or gas equivalent, the reason for which is not currently understood, because measurements are not available. In accordance with certain embodiments of the present disclosure, the sensor systems 300 will be injected or introduced into each zone (e.g., pumped with the fracturing fluid) before placement of a conventional frac ball is inserted into the well bore 105 in order to section off that particular fracture stage. As a result, when an inserted frac ball activates an isolation packer, creating an isolated fracture zone, one or more sensor systems 300 have been introduced into the well bore 105 on the down hole side of the isolation packer to obtain measurements from the fractures and/or production fluid within the wellbore 105 from the subterranean environment 100 associated with that fracture zone, while one or more sensors can then be injected or introduced (e.g., pumped with the fracturing fluid) after insertion of the frac ball (i.e., on the up hole side of the isolation packer) in order to obtain measurements from the fractures and/or production fluid within the wellbore 105 from the subterranean environment 100 associated with that fracture zone.

Such sensor systems 300 may be designed to be smaller than the openings of the isolation ports (within the isolation packers) for each stage, but may be larger or a different shape than the perforation holes so that they do not block (or pass through) any of the openings used for injection of fluids and proppants during the hydraulic fracturing process or during subsequent production stages. This may also ensure that the sensor systems 300 do not pass through the perforation holes and into the fractures produced in the formation 100. In this way, the sensor systems 300 will only obtain measurements associated with the production fluid collected in the wellbore 105 within the particular fracture zone they were intended to be injected into, and do not migrate to other fracture zones within the formation 100. This can be important if it is desired to collect separate measurements for each fracture zone so as to analyze each fracture zone separate from each other. This configuration is able to measure profiles (in both the upstream and downstream sides (fracture zones) of the isolating frac ball) simultaneously, during the hydraulic fracturing of the upstream stage.

For example, measuring pressure versus time during multistage hydraulic fracturing via placement of sensor systems 300 in between stages that are isolated by frac balls/isolation packers/plugs can provide information on hydraulic communication between fracture stages. This knowledge would provide the producer the opportunity to compensate for the communication between each frac stage in the well plan to enhance production and reserves, for example, by adjusting fracking pressure, stage spacing, and/or depth in the current and subsequent stages.

Having this information, operating companies can engineer a schedule for fracturing by which one can redesign the fluid to reduce the friction and so the excessive horsepower needed to generate the required injection rates. Accurate estimation of temperature and chemical makeup would help in understanding the perforation/production efficiency along the wellbore as the sensor systems 300 pass by each of the perforation clusters. For example, changes in temperature from the flowing intervals would give an understanding of how successful was the frac job in that stage/interval. These intervals can be treated at a later time if identified.

Since the location of the frac ball seat in a sliding sleeve is well known, this data from each sequentially injected (and uniquely identifiable) set of sensor systems can be also attributed/geolocated within the specific zone in the wellbore 105 within the subsurface formation 100. Such sensor systems 300 may be recovered to the surface of the formation 100 when the well is brought back on line, after all stages are complete. The sensor systems 300 may be recovered via a coarse screening grid (e.g., sand and/or by magnetic separation) and then interrogated as disclosed herein.

In accordance with certain embodiments of the present disclosure, the sensor system(s) 300 may be miniaturized to the approximate sizes of the proppants, and can be transported within each fracking stage into the formation 100. When a particular sensor 320 is triggered by a preset physical stimulus and threshold, it could transmit a signal or release a uniquely identifiable barcode tracer that can be sensed by an adjacent sensor system or be produced from the injection well 110 or another production well 112. In another embodiment of the present disclosure, the embedded sensors can communicate wirelessly with each other in the formation and with the wellbore. Such embedded sensors can communicate and be energized by acoustic, seismic, electromagnetic, optical, magnetoacoustics. An exemplary method for energizing/communicating with embedded sensors can be realized in accordance with U.S. published patent application no. 2018/000385, which is hereby incorporated by reference herein.

Referring again to FIG. 1, in accordance with certain embodiments, a wireless base station 116 may be inserted down the wellbore 105 (e.g., at the distal end or “toe”), which is in wired communication with equipment 114 on the surface of the formation 100. Such a wireless base station 116 or one or more base stations attached to the wellbore may be able to perform wireless communications with sensors or a pre-loaded housing in the slide sleeve and/or at the distal end of the wellbore to release the sensor system(s) 300 on demand. When released, the sensor system(s) 300 can continuously measure the production environment in each zone as it is successively passes by each perforation. Or, the sensor system(s) 300 may perform communications with one or more short-range wireless sensor read-out nodes 118 embedded within the completion string and/or wellbore 105, wherein these sensor node(s) 118 then are in wireless communication with the sensor system(s) 300.

Another embodiment of the present disclosure may include wire or fiber infrastructure 130 within the casing and sliding sleeve to communicate to equipment 114 on the surface of the formation 100, enabling real-time data acquisition from the sensor system(s) 300 during the completion, injection, and production operations.

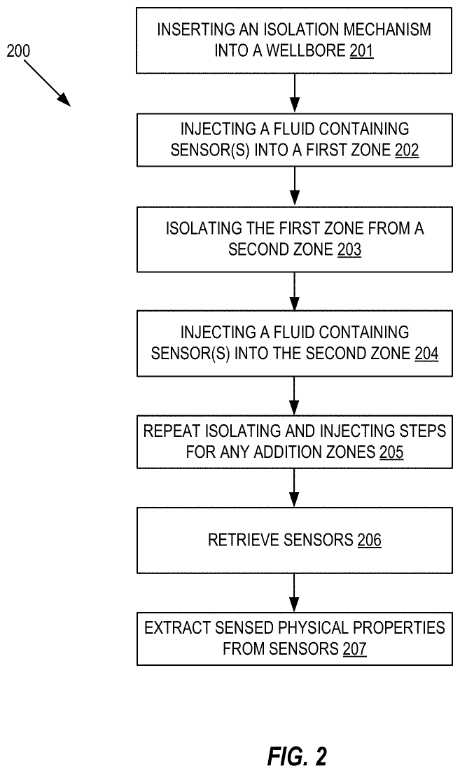

FIG. 2 illustrates a flow diagram of a process 200 configured in accordance with embodiments of the present disclosure. In step 201, a wellbore isolation mechanism (e.g., a completion string) may be inserted into the wellbore 105, such as with a completion string for fracturing. In step 202, a fluid 120 containing one or more such sensor systems 300 is injected into a first zone of the wellbore 105, such as through an injection well 110 utilizing well-known injection (pumping) equipment. The sensor systems 300 collect measurements of physical properties of the environment (e.g., from the production fluid in the first fracture zone in the wellbore 105).

In the step 203, the first zone is isolated from a subsequent second zone, such as through the insertion of a frac ball in a well-known manner In the step 204, a fluid is injected into the second zone of the wellbore 105 containing one or more sensor systems 300. The sensor systems 300 collect measurements of physical properties of the environment (e.g., from the production fluid in the second fracture zone in the wellbore 105).

The step 205 represents a repeat of the foregoing isolating and injecting steps for any additional zones, such as for each fracture stage, which may include the selective insertion of a frac ball for isolating each fracture stage/zone. In the step 206, the sensor systems 300 are retrieved from the wellbore 105, such as during the pumping out of the produced oil/gas.

Referring again to FIG. 1, the sensor systems 300 may be retrieved (e.g., using well-known techniques) to the surface of the subterranean formation 100 from the wellbore 105 and/or directly from the subterranean formation 100 (e.g., through a recovery well 112), where the sensor system(s) 300 may be recharged (e.g., wirelessly) and the memory 314 interrogated (e.g., by a separate computer system 114 (e.g., wirelessly)).

In step 207, the measurements are then retrieved from the sensor systems 300 utilizing any one of the techniques described herein. Such techniques may include wireless communications of the measurements from the individual sensor systems 300 to a wireless base station 116 or node 118, which is in communication 130 with the equipment 114 on the surface of the formation 100. The information from each of the sensor systems 300 may be utilized to create data tables of the measured variables' profiles over time, which may be used to characterize well treatment processes. The comparison and correlation of the data from various sensor systems 300 or as between isolated zones can thus provide information previously unobtainable. As can be appreciated, the sensor systems 300 may be reusable. In accordance with certain embodiments of the present disclosure, the one or more sensor system(s) 300 may be inserted into each of the isolated zones as a result of factors in the wellbore 105, such as a higher density and/or gravity, or pushed by the isolation device (e.g., frac ball or plug, etc.) through the wellbore 105 or be attached to a nozzle, coil tubing, rod, or slide sleeve housing, in order to be conveyed/deployed to the zone of interest.

Note that if the sensor systems 300 incorporate tracers, such as bar-coded tracers or some other type of time-stamped tracers, they can be configured to obtain measurements that are related in time to each other. For example, the time each fracture stage is isolated can be correlated to the tracers inserted within each stage, or the sensor systems 300 can have the tracers encapsulated in materials. Thus, each of the sensor systems 300 introduced to each zone could be identifiable, such as being barcode-tagged, colored differently, or RFID tagged to attribute a specific measurement to sensor systems 300 retrieved from that specific zone.

In accordance with alternative embodiments of the present disclosure, an exemplary instrumented carrier (also simply referred to as a “carrier” herein) may be covered with one or more attached or embedded sensor systems 300, which may be distributed in a desired manner on a surface or inside of the carrier. An exemplary carrier is described within U.S. Provisional Application Ser. No. 62/848,785. Such carriers may then be injected into each of the zones as described with respect to FIG. 2. One or more sensor systems 300 may be attached to the surface of the carrier in a permanent or semi-permanent manner, and may be recoverable, attached to the carrier or detached from the carrier, such as when the production fluid is recovered (i.e., pumped out from the wellbore 105).

In embodiments of the present disclosure, the instrumented carrier may include circuitry (similar to the circuitry described with respect to FIG. 3) configured to obtain multiple measurements utilizing one or more sensors 320 within diverse sensor systems 300 located on the carrier, which can provide unique opportunities to evaluate scenarios where different portions of the carrier may experience different environments.

The carriers may be manufactured using any suitable material for utilization within a wellbore (e.g., wellbore 105) and/or subterranean formation (e.g., formation 100), including, but not limited to, ceramic composites, metals, alloys, plastics and/or dissolvable materials such as polyacrylates, Azo-containing Diols, polyelectrolyte complexes, polycaprolactone, wax, a carboxylic acid, a carboxylic acid derivative, a dissolvable material, or combinations thereof. The sensor systems 300 may be attached (e.g., embedded or mounted) on a surface of the carrier using any suitable means, including with an adhesive. Any number of the sensor systems 300 may be implemented on a particular carrier, and such sensor systems 300 may be implemented to measure any desired physical property of the environment in which they are injected (e.g., the wellbore 105 and/or the subterranean formation 100). A plurality of the sensor systems 300 may be distributed in a relatively uniform manner over a surface of the carrier, or such sensor systems 300 may be implemented on a carrier in any desired distribution pattern.

Furthermore, one or more of the sensor systems 300 may be engineered (configured) to be released from a surface of a carrier in response to a predetermined stimulus, such as a threshold temperature or pressure, and then the released sensor systems 300 may continue to obtain measurements of their specified physical properties. For example, the adhesive utilized to attach the sensor system(s) 300 to the surface may comprise a material that deteriorates upon encountering a certain threshold parameter within the wellbore 105 and/or subterranean formation 100 to thereby release the sensor system(s) 300 from the carrier. Within embodiments of the present disclosure, certain one or more sensor system(s) 300 may be further encapsulated with one or more layers of dissolvable material that deteriorate upon encountering a certain threshold parameter within the wellbore 105 and/or subterranean formation 100 so that such sensor system(s) 300 do not perform their associated measurement(s) until after deterioration of the encapsulant. Such adhesives and encapsulants are well-known in the art, and not shown for the sake of simplicity. The released sensor system(s) 300 may then be retrieved to the surface of the formation 100 for further analysis, including retrieval of information pertaining to the measurements.

In accordance with certain embodiments of the present disclosure, the entire sensor system may be encased in a deteriorating encapsulate system containing a well-known oil/water tracer, which releases its tracers proportional to the concentration of oil and/or water they encounter. An example of such tracers is disclosed in European Patent No. EP1277051B1, which is hereby incorporated by reference herein. Furthermore, though the sensor systems 300 have been described herein as being mounted to or embedded within the surface of the carrier, certain sensor system(s) 300 may be implemented further within the material comprising the carrier. Furthermore, hollow carriers may be utilized in which electronic circuitry (e.g., system 300) for sensor systems 300 and/or power sources 302 may be implemented inside the carrier.

As will be appreciated by one skilled in the art, aspects of the present disclosure may be embodied as a system, method, and/or program product. For example, the sensor systems and any technique for retrieving the information from the sensor systems may be embodied within a system as generally illustrated with respect to FIG. 3. Accordingly, aspects of the present disclosure may take the form of an entirely hardware embodiment, an entirely software embodiment (including firmware, resident software, micro-code, etc.), or embodiments combining software and hardware aspects that may all generally be referred to herein as a “circuit,” “circuitry,” “module,” or “system.” Furthermore, aspects of the present disclosure may take the form of a program product embodied in one or more computer readable storage medium(s) having computer readable program code embodied thereon. (However, any combination of one or more computer readable medium(s) may be utilized. The computer readable medium may be a computer readable signal medium or a computer readable storage medium.)

A computer readable storage medium may be, for example, but not limited to, an electronic, magnetic, optical, electromagnetic, infrared, biologic, atomic, or semiconductor system, apparatus, controller, or device, or any suitable combination of the foregoing. More specific examples (a non-exhaustive list) of the computer readable storage medium may include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a magnetic storage device, or any suitable combination of the foregoing. In the context of this document, a computer readable storage medium may be any non-transitory and/or tangible medium that can contain or store a program for use by or in connection with an instruction execution system, apparatus, controller, or device. Program code embodied on a computer readable signal medium may be transmitted using any appropriate medium, including but not limited to wireless, wire line, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, controller, or device.

The flowchart and block diagrams in the figures illustrate architecture, functionality, and operation of possible implementations of systems, methods, and program products according to various embodiments of the present disclosure. It should also be noted that, in some implementations, the functions noted in the steps of FIG. 2 may occur out of the order illustrated. For example, two steps shown in succession may, in fact, be executed substantially concurrently, or the steps may sometimes be executed in the reverse order, depending upon the functionality involved.

It will also be noted that each block of the block diagram of FIG. 3, and combinations of blocks in the block diagram, can be implemented by special purpose hardware-based systems that perform the specified functions or acts, or combinations of special purpose hardware and computer instructions. For example, a module may be implemented as a hardware circuit comprising custom VLSI circuits or gate arrays, off-the-shelf semiconductors such as logic chips, transistors, controllers, or other discrete components. A module may also be implemented in programmable hardware devices such as field programmable gate arrays, programmable array logic, programmable logic devices, or the like.

Reference throughout this specification to “one embodiment,” “embodiments,” or similar language means that a particular feature, structure, or characteristic described in connection with the embodiments is included in at least one embodiment of the present disclosure. Thus, appearances of the phrases “in one embodiment,” “in an embodiment,” “embodiments,” and similar language throughout this specification may, but do not necessarily, all refer to the same embodiment. Furthermore, the described features, structures, aspects, and/or characteristics of the disclosure may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

In the descriptions herein, numerous specific details are provided to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations may be not shown or described in detail (e.g., pumping equipment) to avoid obscuring aspects of the disclosure.

Benefits, advantages, and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims.

Those skilled in the art having read this disclosure will recognize that changes and modifications may be made to the embodiments without departing from the scope of the present disclosure. It should be appreciated that the particular implementations shown and described herein may be illustrative of the disclosure and its best mode and may be not intended to otherwise limit the scope of the present disclosure in any way. Other variations may be within the scope of the following claims.

While this specification contains many specifics, these should not be construed as limitations on the scope of the disclosure or of what can be claimed, but rather as descriptions of features specific to particular implementations of the disclosure. Headings herein may be not intended to limit the disclosure, embodiments of the disclosure or other matter disclosed under the headings.

The terminology used herein is for the purpose of describing particular embodiments only and is not intended to be limiting of the disclosure. As used herein, the singular forms “a,” “an,” and “the” may be intended to include the plural forms as well, unless the context clearly indicates otherwise. Herein, the term “or” may be intended to be inclusive, wherein “A or B” includes A or B and also includes both A and B.

The corresponding structures, materials, acts, and equivalents of all means or step plus function elements in the claims below may be intended to include any structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as may be suited to the particular use contemplated.

What is claimed is:

1. A method comprising:
injecting a first fluid containing a first set of one or more sensor systems into a first zone of the wellbore, wherein the first set of one or more sensor systems measures a physical property associated with the first zone;
isolating the first zone from a second zone with a wellbore isolation mechanism inserted into the wellbore; and
injecting a second fluid containing a second set of one or more sensor systems into the second zone, wherein the second set of one or more sensor systems measures a physical property associated with the second zone.

2. The method as recited in claim 1, further comprising:
retrieving from the wellbore the first set of one or more sensor systems and the second set of one or more sensor systems; and
extracting the measured physical properties from the first set of one or more sensor systems and the second set of one or more sensor systems.

3. The method as recited in claim 2, wherein each of the first set of one or more sensor systems includes a first identification tag, and wherein each of the second set of one or more sensor systems includes a second identification tag, wherein the first and second identification tags are distinguishable from each other so that the first set of one or more sensor systems are associated with the first zone and the second set of one or more sensor systems are associated with the second zone.

4. The method as recited in claim 1, wherein the first and second fluids include a fracking fluid, the method further comprising:
fracking a subterranean formation in proximity to the first zone with the first fluid; and
fracking the subterranean formation in proximity to the second zone with the second fluid.

5. The method as recited in claim 4, wherein the wellbore isolating mechanism comprises:
an activated packer suitable for isolating the first zone from the second zone; and
a ball-activated sleeve suitable for preventing the second fluid from entering into the first zone.

6. The method as recited in claim 1, wherein the injecting of the first fluid and the injecting of the second fluid are performed before, during, or after fracking a subterranean formation at each of the first and second zones.

7. The method as recited in claim 5, wherein the physical properties measured in the first zone pertain to the subterranean formation that is in proximity to the first zone, and wherein the physical properties measured in the second zone pertain to the subterranean formation that is in proximity to the second zone.

8. The method as recited in claim 1, wherein the physical properties are selected from a group consisting of temperature, pressure, pH, resistivity, ion charge, relative proportion of oil and water, CH₄ content, and CO₂ content, electromagnetic, acoustic, seismicity, conductivity, dielectric impedance, optical, wherein the physical properties in the first zone pertain to production fluids retrieved in the first zone, and wherein the physical properties in the second zone pertain to production fluids retrieved in the second zone.

9. The method as recited in claim 4, further comprising pumping a production fluid from the first and second zones, wherein the production fluid contains the first set of one or more sensor systems and the second set of one or more sensor systems, and a hydrocarbon retrieved from the subterranean formation.

10. The method as recited in claim 1, wherein the physical properties measured in the first zone pertain to production fluids retrieved in the first zone, and wherein the physical properties in the second zone pertain to production fluids retrieved in the second zone.

11. The method as recited in claim 1, further comprising:
retrieving from the wellbore a first tracer with a unique bar code tag from the first set of one or more sensor systems and a second tracer with a unique bar code tag from the second set of one or more sensor systems; and
extracting the measured physical properties from the first set of one or more sensor systems and the second set of one or more sensor systems.
